(19) United States
(12) Patent Application Publication
(10) Pub. No.: US 2015/0378707 A1
(43) Pub. Date: Dec. 31, 2015

(54) MOBILE TERMINAL AND METHOD FOR CONTROLLING THE SAME

(71) Applicant: LG ELECTRONICS INC., Seoul (KR)

(72) Inventors: Mihyun PARK, Seoul (KR); Dongsu HAN, Seoul (KR); Woohyoung SHIN, Seoul (KR); Seonghyok KIM, Seoul (KR); Sungho WOO, Seoul (KR)

(73) Assignee: LG ELECTRONICS INC., Seoul (KR)

(21) Appl. No.: 14/734,914

(22) Filed: Jun. 9, 2015

(30) Foreign Application Priority Data
Jun. 27, 2014 (KR) 10-2014-0079484

(51) Int. Cl. G06F 9/445; G06F 3/0486; G06F 3/0482; G06F 3/0481; G06F 3/0488

(52) U.S. Cl. CPC G06F 8/61; G06F 3/04817; G06F 3/0488; G06F 3/0482; G06F 3/0486

(57) ABSTRACT

A mobile terminal including a wireless communication unit configured to provide wireless communication; a touchscreen configured to display at least one page including at least one application icon; and a controller configured to display a first screen for installing a specific application on the touchscreen, display a second screen for setting a position at which an icon corresponding to the specific application will be displayed on the touchscreen after being installed, upon reception of an input for installing the specific application, and display the icon of the specific application at the position on the touchscreen in response to a predetermined touch input on the displayed second screen.

### CROSS-REFERENCE TO RELATED APPLICATIONS

This application claims priority to Korean Patent Application No. 10-2014-0079484 filed on 27 Jun., 2014 in Korea, the entire contents of which are hereby incorporated by reference in their entirety.

### BACKGROUND OF THE DISCLOSURE

1. Field of the Disclosure

The present invention relates to a mobile terminal and a method for controlling the same to enable convenient installation of applications.

2. Background of the Disclosure

Terminals may be generally classified as mobile/portable terminals or stationary terminals. Mobile terminals may also be classified as handheld terminals or vehicle mounted terminals. Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

In the meantime, as applications that can be used in a terminal are frequently installed, it is necessary to conveniently determine an application installation position in the terminal.

### SUMMARY OF THE DISCLOSURE

Accordingly, an object of the present invention is to address the above-noted and other problems.

Another object of the present invention is to provide a mobile terminal configured to enable easy selection of an application icon display position and easy recognition of an application icon display position, and a method for controlling the same.

To accomplish the objects of the present invention, according to an embodiment of the present invention, there is provided a mobile terminal, including: a touchscreen configured to display at least one page including at least one application icon; and a controller configured to display a first screen for installing an application on the touchscreen, to display a second screen for setting a position at which a specific application will be installed and displayed, upon reception of input for installing the specific application, and to display an icon of the specific application at a position when the position is selected by predetermined touch input.

The second screen may include at least one reduced screen corresponding to the at least one page.

The controller may be configured to display the reduced screen so an area in which an icon is displayed is discriminated from an area capable of displaying the icon of the specific application.

The controller may be configured to display a progress bar indicating download progress of an installation file of the specific application on the first screen and to display the second screen upon reception of input applied to the progress bar.

The controller may be configured to display at least one reduced screen corresponding to the at least one page in an area of the second screen and to display at least one reduced screen corresponding to at least one application drawer in another area of the second screen.

The controller may be configured to display an application drawer for selecting a display position of the icon of the specific application upon reception of touch input applied to the displayed icon of the specific application.

The controller may be configured to display the first screen translucently and to display the second screen such that the second screen and the first screen overlap.

The controller may be configured to restore the first screen and to display the restored first screen upon selection of the position.

The controller may be configured to navigate a position at which a virtual icon corresponding to the specific application will be displayed.

When touch input applied to an installation button displayed on the first screen and maintained for a predetermined time is received, the controller may be configured to display the virtual icon at a position to which the touch input is applied, and to navigate a position at which the specific application will be displayed according to drag input applied to the virtual icon.

The controller may be configured to display a notification bar indicating installation state of the specific application and to display the second screen upon reception of input for installing the specific application.

According to another embodiment of the present invention, there is provided a mobile terminal, including: a touchscreen; and a controller configured to display at least one market application for installing a specific application upon reception of touch input applied to a specific position of the touchscreen, to install the specific application through the market application and to display an icon corresponding to the specific application at the specific position.

The controller may be configured to display at least one recommended application upon reception of touch input applied to a specific position of the touchscreen and to display an icon corresponding to a selected recommended application at the specific position.

The controller may be configured to display at least one application related to a category of a specific folder upon reception of touch input applied to the specific folder and to display an icon corresponding to a selected related application in the specific folder.

According to another embodiment of the present invention, there is provided a method for controlling a mobile terminal, including: displaying a first screen for installing an application on a touchscreen; receiving input for installing a specific application; displaying a second screen for setting a position at which the specific application will be installed and displayed; and displaying an icon of the specific application at a position when the position is selected by predetermined touch input.

According to another embodiment of the present invention, there is provided a method for controlling a mobile terminal, including: receiving touch input applied to a specific position of a touchscreen; displaying at least one market application for installing a specific application; installing the specific application through the market application; and displaying an icon corresponding to the specific application at the specific position.

Effects of the mobile terminal and the method for controlling the same according to an embodiment of the present invention will now be described.

According to at least one of embodiments of the present invention, it is possible to easily select an application icon display position and to easily recognize an application icon display position.

According to at least one of embodiments of the present invention, it is possible to select a display position of an icon corresponding to a specific application during installation of the specific application.

According to at least one of embodiments of the present invention, it is possible to easily select an icon display position on a page which is displayed as a home screen or an application drawer.

According to at least one of embodiments of the present invention, it is possible to simultaneously recognize a screen for installing an application and a screen for setting a position at which the application will be installed and displayed by translucently displaying the screen for installing the application.

According to at least one embodiment of the present invention, it is possible to intuitively navigate positions at which a virtual icon can be displayed by displaying the virtual icon at a position corresponding to touch input when the touch input is maintained.

According to at least one of embodiments of the present invention, it is possible to easily select or recognize a position at which an application icon will be displayed according to touch input applied to a notification bar that indicates an application installation state.

According to at least one of embodiments of the present invention, it is possible to display an application icon at a specific position of a touchscreen, to which touch input is applied.

According to at least one of embodiments of the present invention, it is possible to easily determine an application icon installation position per folder category by displaying applications related to a folder category.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a block diagram of a mobile terminal in accordance with the present disclosure;

FIG. 2 is a flowchart illustrating a method for controlling a mobile terminal according to an embodiment of the present disclosure;

FIGS. 3 and 4 illustrate selection of an application icon display position according to an embodiment of the present disclosure;

FIG. 5 illustrates display of a second screen according to an embodiment of the present disclosure;

FIG. 6 illustrates selection of a display position of an icon corresponding to an application during installation of the application according to an embodiment of the present disclosure;

FIGS. 7 and 8 illustrate selection of an application icon display position on a page and an application drawer according to an embodiment of the present disclosure;

FIG. 9 illustrates translucent display of a screen for installing an application according to an embodiment of the present disclosure;

FIG. 10 illustrates operation of navigating application icon display positions according to an embodiment of the present disclosure;

FIGS. 11-13 illustrate selection of an application icon display position using a notification bar according to an embodiment of the present disclosure;

FIG. 14 is a flowchart illustrating a method for controlling a mobile terminal according to another embodiment of the present disclosure;

FIGS. 15-17 illustrate direct display of an application icon at a selected specific position of a touchscreen according to an embodiment of the present disclosure;

FIGS. 18 and 19 illustrate selection of an application icon display position from a folder according to an embodiment of the present disclosure;

FIG. 20 illustrates selection of the size of a displayed application icon according to an embodiment of the present disclosure; and

FIGS. 21 and 22 illustrate selection of a data storage position using a notification bar according to an embodiment of the present disclosure.

### DETAILED DESCRIPTION OF THE PREFERRED EMBODIMENTS

Description will now be given in detail according to embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another. When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

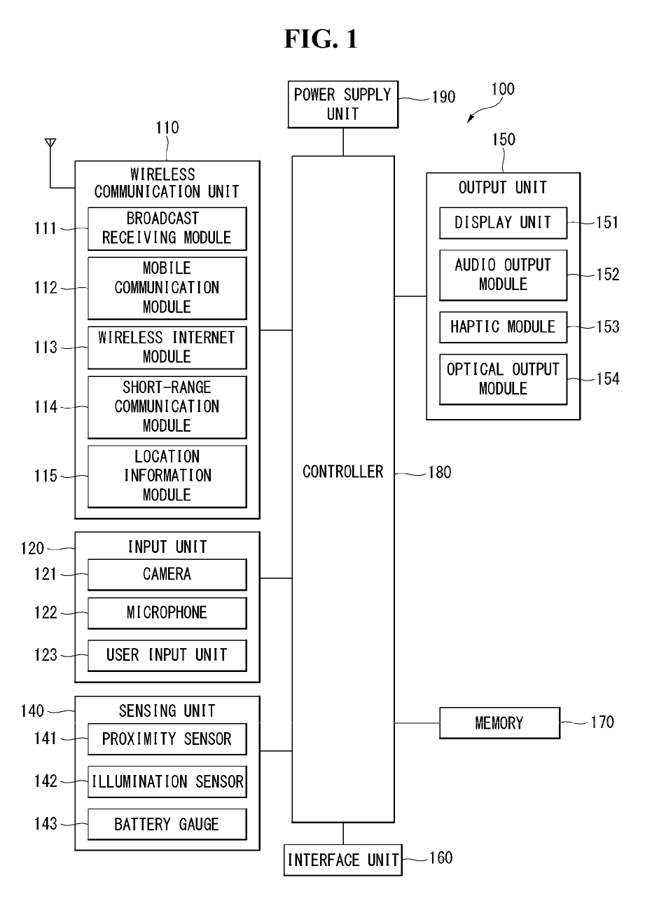

Reference is now made to FIG. 1, where FIG. 1 is a block diagram of a mobile terminal in accordance with the present disclosure. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge 143, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access) Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example. The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information. In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen. The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition. The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging. The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof. Further preferred embodiments will be described in more detail with reference to additional drawing figures. It is understood by those skilled in the art that the present features can be embodied in several forms without departing from the characteristics thereof.

A description will be given of embodiments with respect to a control method that can be implemented in the aforementioned mobile terminal with reference to the attached drawings. Those skilled in the art will appreciate that the present invention may be performed in other specific ways than those set forth herein without departing from the spirit and essential characteristics of the present invention.

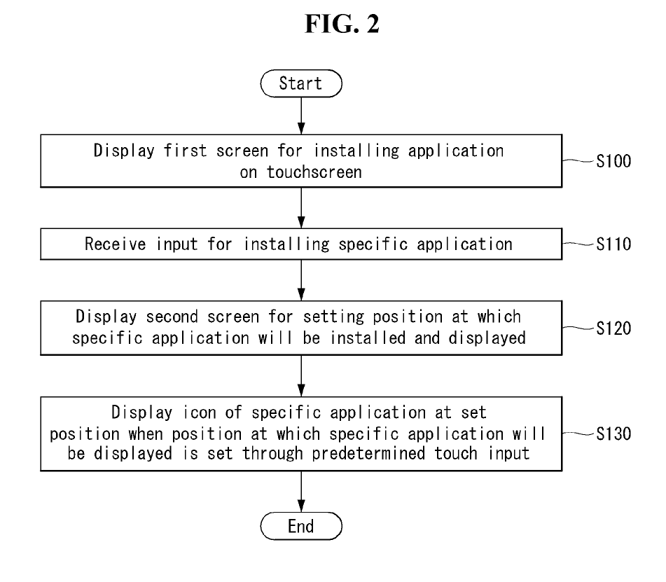

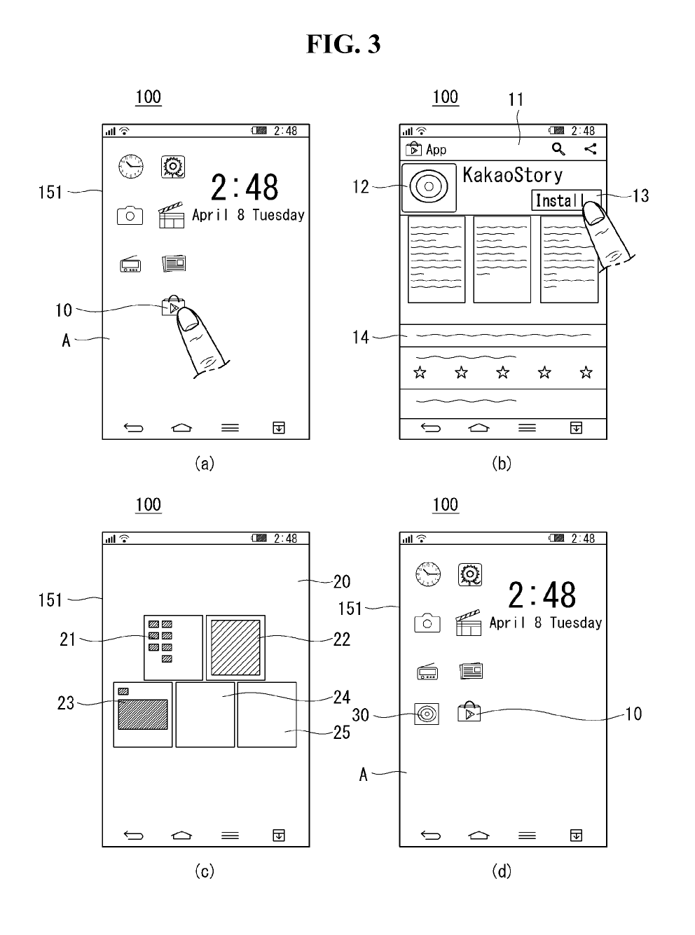

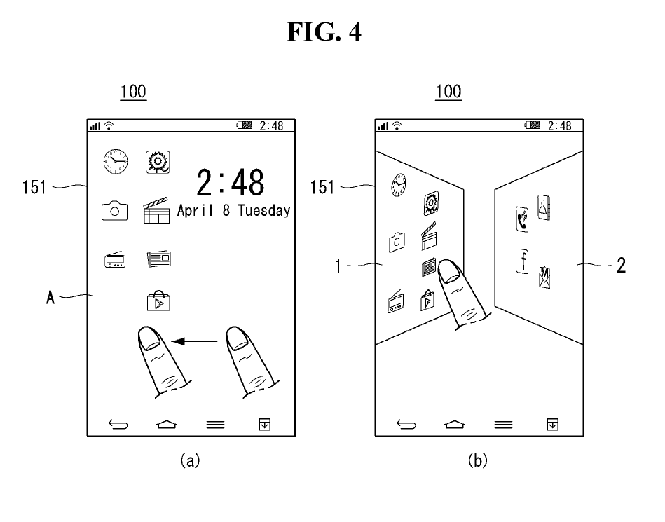

FIG. 2 is a flowchart illustrating a method for controlling a mobile terminal according to an embodiment of the present invention and FIGS. 3 and 4 illustrate selection of an application icon display position according to an embodiment of the present invention. The method for controlling a mobile terminal according to an embodiment of the present invention can be implemented in the mobile terminal 100 described above with reference to FIG. 1. The method for controlling a mobile terminal according to an embodiment of the present invention and operations of the mobile terminal 100 for implementing the method will now be described in detail with reference to the attached drawings.

Referring to FIG. 2, the controller 180 can display a first screen for installing an application on the touchscreen (S100). FIG. 3(a) shows a home screen A displayed on the touchscreen 151 of the mobile terminal 100. A user can select a market application 10 on the home screen A for installation of an application. The market application 10 may refer to an application capable of installing applications. The market application 10 is not limited to a specific application and can be any application capable of installing applications.

The controller 180 can display the first screen 11 for installing an application on the touchscreen 151, as shown in FIG. 3(b), by executing the selected market application 10. The first screen 11 may be an execution screen of the market application 10. The controller 180 can display an icon 12 corresponding to the installed application on the first screen 11. The controller 180 can display an installation button 13 for installing the application on the first screen 1I. The controller 180 can display a description region 14 with respect to the installed application on the first screen 11.

Referring back to FIG. 2, the controller 180 can receive input for installing a specific application (S110). As shown in FIG. 3(b), the user can select the installation button 13 for installing an application. The controller 180 can receive the selection of the user as input for installing a specific application. However, the input for installing a specific application is not limited thereto and may be predetermined touch input applied to the icon 12 or the description region 14. The predetermined touch input includes touch inputs, such as short touch, long touch and multi-touch, or a combination thereof.

The controller 180 can install the specific application in the mobile terminal 100 upon reception of the input. In particular, the controller 180 can download an installation file of the specific application using the wireless communication unit 110 through an external communication network, and install the specific application in the mobile terminal 100 upon completion of download of the installation file.

Referring back to FIG. 2, the controller 180 can display a second screen for setting a position at which the specific application is installed and displayed (8120). FIG. 3(c) shows the second screen 20 displayed on the touchscreen 151 according to an embodiment. The second screen 20 may include one or more reduced screens 21 to 25 respectively corresponding to one or more pages.

One of the pages includes application icons and can be displayed on the home screen, as shown in FIG. 4(a). The user can touch a specific region of the home screen A and drag the touch in order to view another page. The controller 180 can move the previous page 1 in the drag direction, as shown in FIG. 4(b). In addition, the controller 180 can display the next page 2.

Referring back to FIG. 3(c), the reduced screens 21 to 25 respectively corresponding to five pages are displayed on the second screen 20. However, this is exemplary and the number of displayed pages can be changed as necessary. The reduced pages 21 to 25 display applications, which are displayed in the corresponding pages. The reduced screen 21 corresponds to the page shown in FIG. 3(a) and displays seven application icons.

Referring back to FIG. 2, when the position at which the specific application is displayed is selected through the predetermined touch input, the controller 180 can display an icon corresponding to the specific application at the selected position (S130). The user can select a page for displaying the icon of the specific application from the second screen 20. When the user selects the reduced screen 21, the controller 180 can display the icon 30 of the specific application on the page corresponding to the reduced screen 21, as shown in FIG. 3(d).

In one embodiment, the controller 180 can display the icon 30 in a region of the page, which is selected by the user. The user can select a region to display the icon 30 in the reduced screen 21. Alternatively, the user can select a region to display the icon 30 in the page corresponding to the reduced screen 21 after display of the page.

In another embodiment, the display position of the icon 30 may be determined in predetermined order. For example, the icon 30 can be displayed in a region corresponding to the uppermost row of the leftmost column in a blank area of the page. However, the icon display position determination order is not limited thereto and may be changed as necessary. Accordingly, the user can install the specific application on the first screen 11 corresponding to the execution screen of the market application 10 and, simultaneously, select the position at which the specific application is installed. Accordingly, the user can conveniently select the position at which the icon of the specific application is displayed. In addition, the user can immediately recognize the position at which the icon of the specific application is displayed.

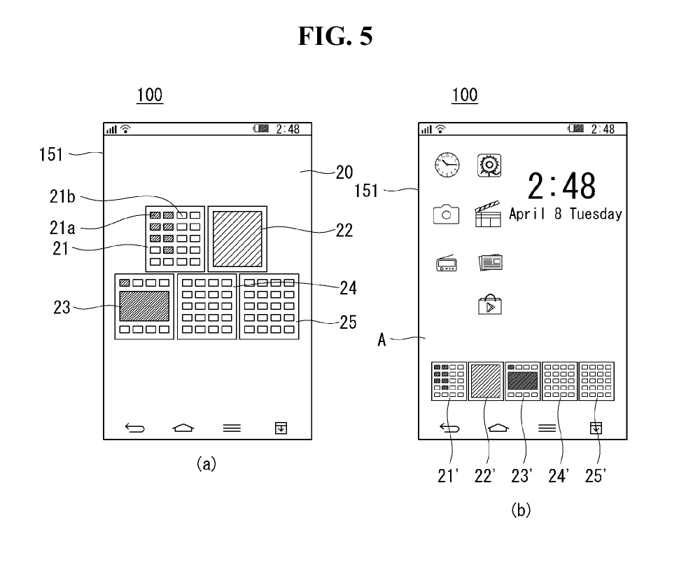

Next, FIG. 5 illustrates display of the second screen according to an embodiment of the present invention. Referring to FIG. 5(a), the controller 180 can display the reduced screens 21 to 25 on the second screen 20 so regions of the reduced screens 21 to 25, in which icons are displayed, are discriminated from regions in which icons can be displayed.

For example, the controller 180 can display the reduced screen 21 corresponding to the page shown in FIG. 3(a). Shaded regions 21a of the reduced screen 21 may refer to regions in which application icons are currently displayed. Blank regions 21b may refer to regions in which application icons can be displayed.

Referring to FIG. 5(b), the controller 180 can display reduced screens 21′ to 25′ in the lower part of the home screen A. The controller 180 can display the reduced screen 21′ corresponding to the page currently displayed on the home screen A such that the reduced screen 21′ is discriminated from other reduced screens 22′ to 25′. Accordingly, the user can intuitively recognize a region in each page, in which an application can be displayed, and thus the user can easily select an icon display position.

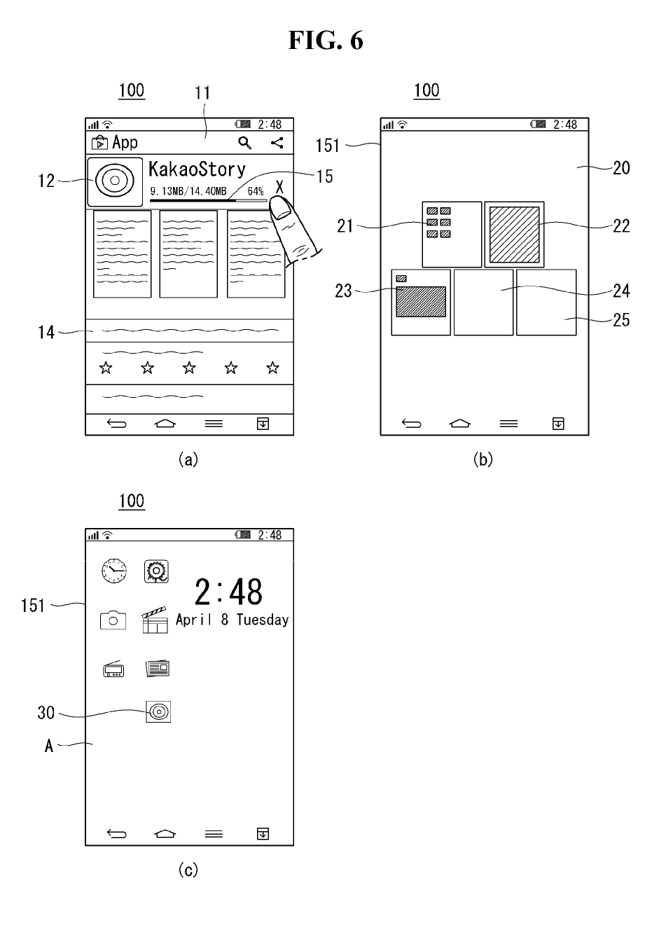

FIG. 6 illustrates selection of a display position of an icon corresponding to an application during installation of the application according to an embodiment of the present invention. Referring to FIG. 6(a), the controller 180 can display a progress bar 15 that indicates a download progress state of a specific application installation file. The application installation file refers to a file for installing a specific application in the mobile terminal 100. Any application installation file can correspond to the specific application installation file if the file can install a specific application in the mobile terminal 100.

Referring to FIG. 6(b), the controller 180 can display the second screen 20 upon reception of input to the progress bar 15. Since the reduced screens 21 to 25 displayed on the second screen 20 are substantially the same as those shown in FIG. 3(c), detailed description thereof is omitted. When the user selects the reduced screen 21 displayed on the second screen, the controller 180 can display the icon 30 corresponding to the specific application, as shown in FIG. 6(c).

Accordingly, the user can select a position at which the icon corresponding to the specific application will be displayed even during download of the specific application installation file, and thus the user can conveniently select the display position of the icon of the specific application. In addition, the user can immediately recognize the display position of the icon of the specific application. According to another embodiment, the progress bar 15 can indicate an installation progress of the downloaded specific application installation file. In this instance, the user can select the display position of the icon 30 even during installation of the specific application at a predetermined position.

Upon completion of installation of the specific application, the controller 180 can display the icon 30 at the position selected by the user. In addition, the controller 180 can also display the icon 30 at the predetermined position. However, the present invention is not limited thereto and the controller 180 can display the icon 30 only at the position selected by the user.

Accordingly, the user can select the position at which the icon corresponding to the specific application will be displayed even during installation of the specific application and thus the user can conveniently select the display position of the icon of the specific application. Furthermore, the user can immediately recognize the display position of the icon of the specific application.

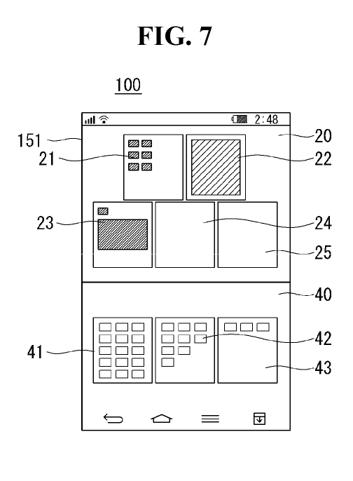

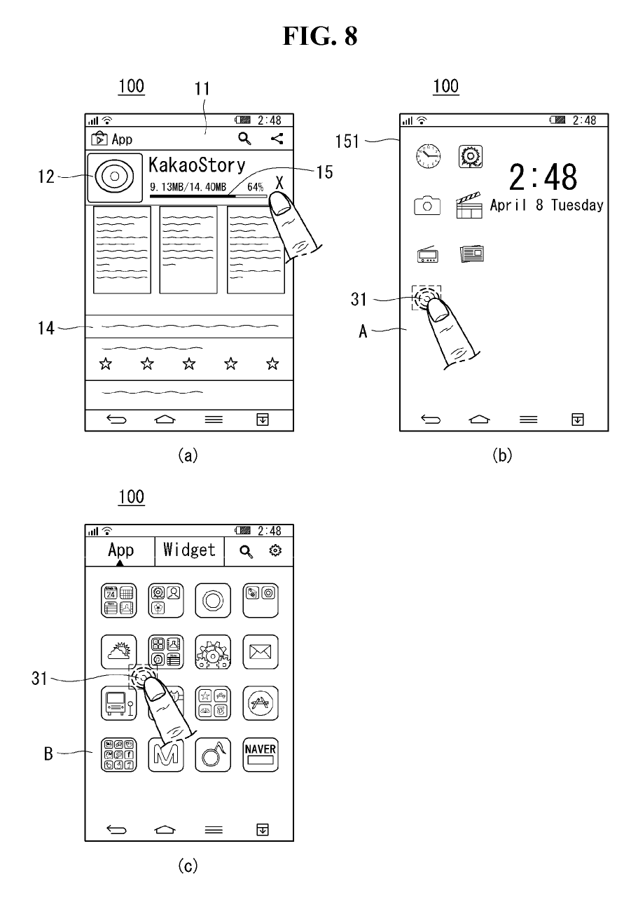

Next, FIGS. 7 and 8 illustrate selection of an application icon display position in a page and an application drawer according to an embodiment of the present invention. Referring to FIG. 7, the controller 180 can display the reduced screens 21 to 25 respectively corresponding to the pages, described above with reference to FIG. 4, in one area 20 of the second screen. In addition, the controller 180 can display one or more reduced screen 41 to 43 respectively corresponding to one or more application drawers in the other area 40 of the second screen.

The application drawer can refer to a page in which icons of applications installed in the mobile terminal are collected. The page described above with reference to FIG. 4 can be discriminated from the application drawer since the page includes icons to be displayed on the home screen A. Accordingly, the user can easily select a position at which an icon corresponding to an installed application will be displayed from reduced screens 21 to 25 corresponding to pages or reduced screens 41 to 43 corresponding to application drawers.

According to one embodiment, the controller 180 can display the second screen shown in FIG. 7 first when the user applies input to the first screen 11 shown in FIG. 3. When the user select the area 20 of the second screen, the controller 180 can magnify the area 20 and display the area 20 in the entire area of the touchscreen 151, as shown in FIG. 3(c). When the user select the other area 40 of the second screen, the controller 180 can display the other area 40 in the entire area of the touchscreen 151.

Referring to FIG. 8(a), the controller 180 can display the first screen 11. The controller 180 can display an icon on the page displayed on the home screen A through the procedure described above with reference to FIG. 6. Referring to FIG. 8(b), the controller 180 can display an icon 31 in a different manner. While the icon 31 is indicated by a dotted line in FIG. 8(b), the present invention is not limited thereto. The controller 180 can display the icon 31 such that the color, size or the like of the icon 31 is discriminated form other icons.

When the user selects the icon 31, the controller 180 can display an application drawer B for selecting a display position of the icon 31. When the user selects a specific position, the controller 180 can display the icon 31 at the selected position in the application drawer B.

According to one embodiment, the controller 180 can display the icon 31 at a position at which the user touches the icon 31 in FIG. 8(b). When the user maintains touch input for a predetermined time, the controller 180 can display the application drawer B as shown in FIG. 8(c). The user can touch the icon 31 and drag the touch to the left and right or up and down. Then, the controller 180 can display another application drawer positioned in the drag direction, on the touchscreen 151.

FIG. 8 shows that the display position of the icon 31 in the corresponding page is determined and then the icon display position in the application drawer is determined. However, the present invention is not limited thereto and the controller 180 can determine the icon display position in the application drawer first and then determine the icon display position in the page. Accordingly, the user can easily select the display position of the icon of the installed specific application in the page and the application drawer.

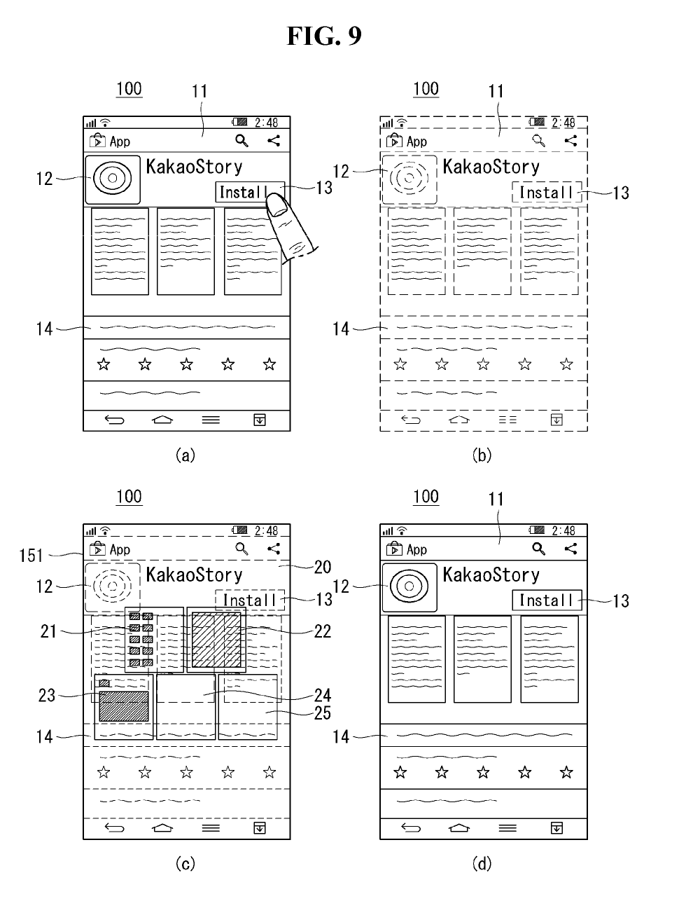

FIG. 9 illustrates translucent display of the first screen 11 for installing an application according to an embodiment of the present invention. Referring to FIG. 9(a), when the user selects the installation button 13, the controller 180 can install a specific application. In this instance, the controller 180 can display the first screen in a translucent manner, as shown in FIG. 9(b). According to an embodiment, the controller 180 can translucently display the progress bar indicating installation progress during installation of the specific application.

Referring to FIG. 9(c), the controller 180 can display the second screen 20 on the first screen 11 so the second screen 20 and the first screen 11 overlap. The controller 180 can display the first screen 11 in a translucent manner and, simultaneously, display the second screen 20. In addition, the controller 180 can sequentially perform translucent display of the first screen 11 and display of the second screen 20.

The user can select the position at which the specific application icon will be displayed from the reduced screens 21 to 25. Upon selection of the position, the translucent first screen can be restored, as shown in FIG. 9(d). Accordingly, the user can select the icon display position while viewing the description region 14 of the specific application or the progress bar indicating application installation progress.

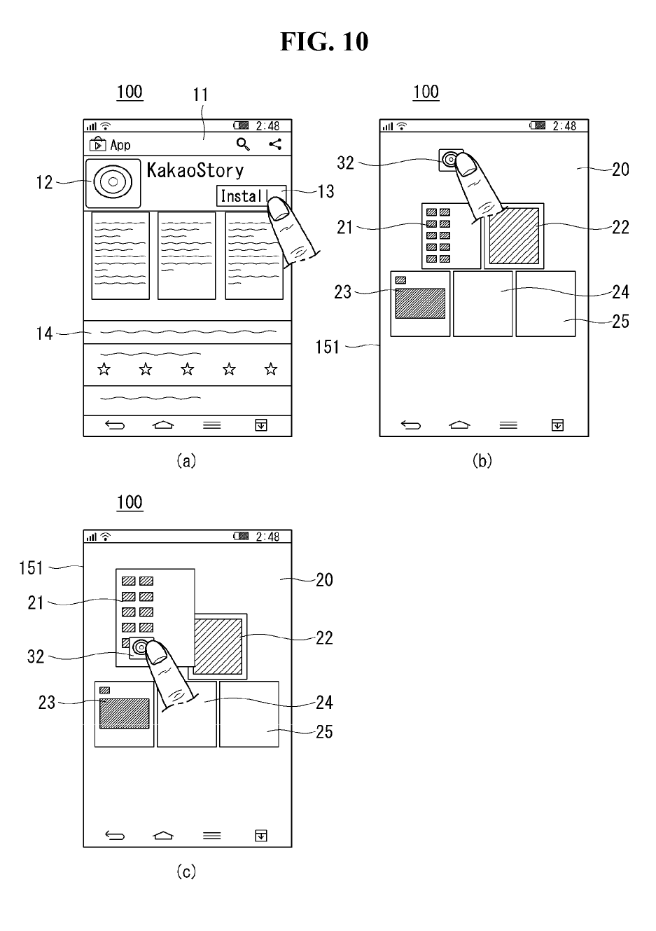

FIG. 10 illustrates operation of navigating application icon display positions according to an embodiment of the present invention. Referring to FIG. 10(a), the controller 180 can receive touch input which is applied to the installation button 13, displayed on the first screen 11, and maintained for a predetermined time. The present invention is not limited thereto and the touch input may be preset to various touch inputs such as short touch and multi-touch or a combination thereof.

The controller 180 can display a virtual icon 32 corresponding to the specific application at the position to which the touch input applied, as shown in FIG. 10(b), upon reception of the touch input. The user can navigate positions at which the specific application can be displayed according to drag input applied to the virtual icon 32. Navigation can refer to an operation for selecting a position at which the virtual icon 32 will be finally displayed.

Referring to FIG. 10(c), the user can drag the virtual icon 32 to the specific reduced screen 21 from among the reduced screens 21 to 25 corresponding to pages. The controller 180 can magnify the reduced screen 21. The user can move the virtual icon 32 between reduced screens 21 to 25 through drag input. Furthermore, the user can select the virtual icon display position by dragging the virtual icon 32 to a position of an icon displayed on the selected reduced screen. In this instance, the controller 180 can move a pre-displayed icon in a predetermined direction from the original position thereof. Alternatively, the controller 180 can delete the pre-displayed icon from the corresponding page.

While description of the aforementioned operation is based on pages in FIG. 10, the operation can be equally applied to operation based on the application drawer. Accordingly, the user can conveniently select the position of the specific application icon.

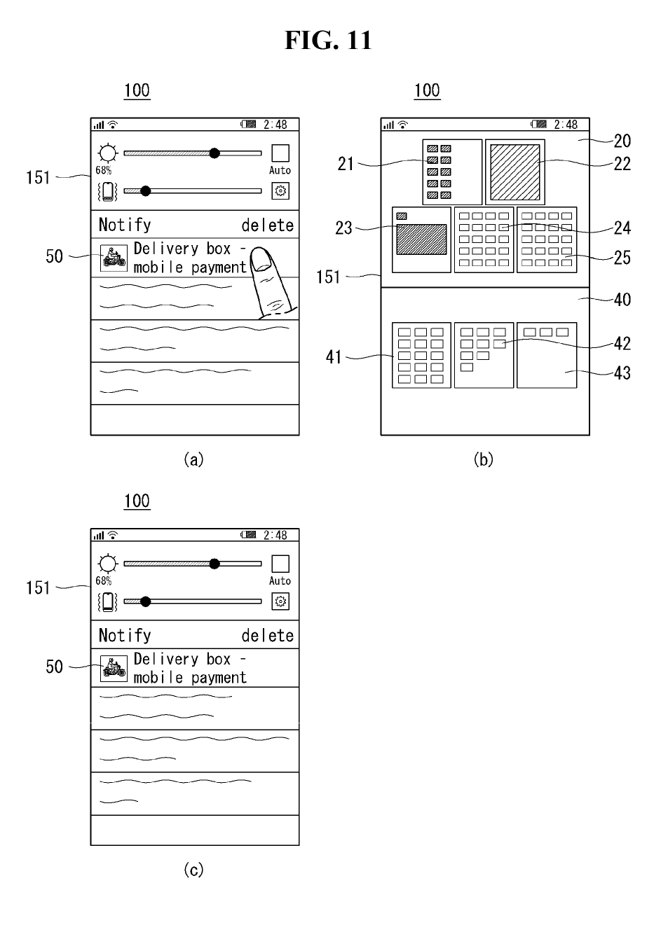

FIGS. 11-13 illustrate selection of an application icon display position using a notification bar according to an embodiment of the present invention. The controller 180 can indicate application installation file download state or application installation state through the notification bar. FIG. 11(a) shows a notification bar 50 indicating that a specific application has been installed.

When the user selects the notification bar 50, the controller 180 can display one or more reduced screens 21 to 25 respectively corresponding to one or more pages, described above with reference to FIG. 4, in the area 20 of the second screen, as shown in FIG. 11 (b). In addition, the controller 180 can display one or more reduced screens 41 to 43 respectively corresponding to one or more application drawers in the area 40 of the second screen.

However, the present invention is not limited thereto and the controller 180 can display only the area 20 or the area 40 in the entire area of the touchscreen 151. The following procedure of selecting an icon display position is substantially the same as the aforementioned procedure and thus detailed description thereof is omitted.

Upon selection of a display position of the icon of the specific application, the controller 180 can display the icon at the selected position. In this instance, the icon may be displayed at a predetermined position when the specific application is installed. Accordingly, the controller 180 can delete the icon displayed at the predetermined position. However, the present invention is not limited thereto and the icon displayed at the predetermined position may be maintained.

The controller 180 can display the screen on which the notification bar 50 is displayed upon selection of the display position of the specific application icon, as shown in FIG. 1 (c). Accordingly, the user can easily select the specific application icon display position by selecting the notification bar even when the icon of the specific application is displayed at the predetermined position.

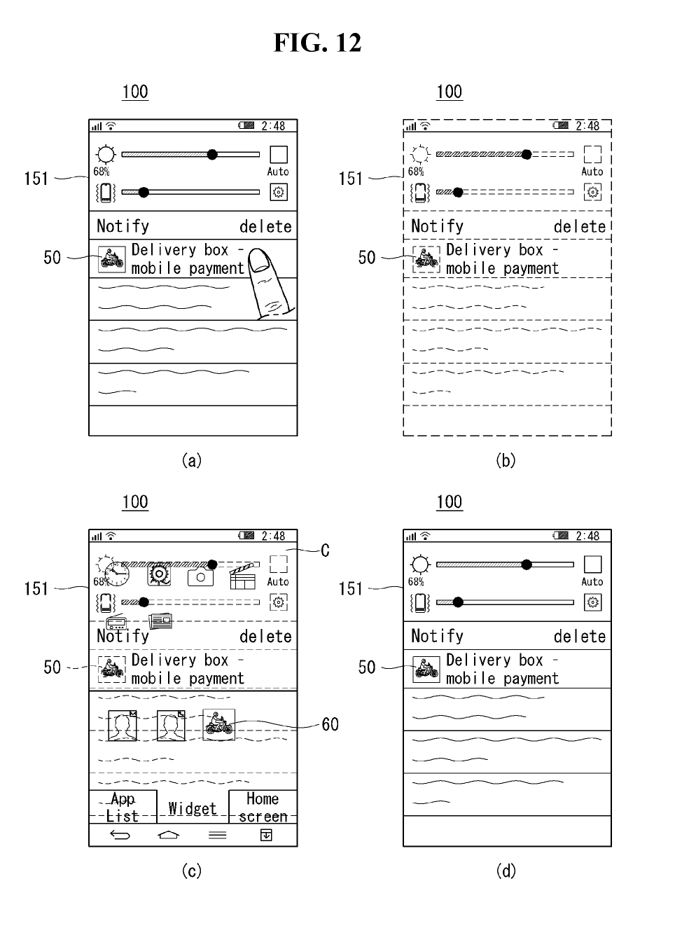

Referring to FIG. 12(a), the user can select the notification bar 50 indicating that the specific application has been installed. The controller 180 can display a screen C for selecting positions of widgets 60 to 62 corresponding to the specific application, as shown in FIG. 12(b). A widget can refer to a user interface that reflects and displays an execution result of the specific application. The screen C for selecting a widget position may be the page displayed on the home screen A or a widget drawer.

The user can select a specific widget 62 and drag the selected widget 62 to the screen C for selecting a widget position so as to select a display position of the widget 62. The controller 180 can display the second screen 20 described above with reference to FIG. 3(c) according to an embodiment. The controller 180 can display the reduced screens 21 to 25 corresponding to pages in the area 20 of the second screen, as described above with reference to FIG. 7, according to another embodiment. The controller 180 can display a reduced screen corresponding to a widget drawer in the other area 40 of the second screen.

Accordingly, the user can easily select a display position of a widget corresponding to the specific application through the notification bar 50. The above description of selection of a display position of a specific application icon can be equally applied to selection of a display position of a widget.

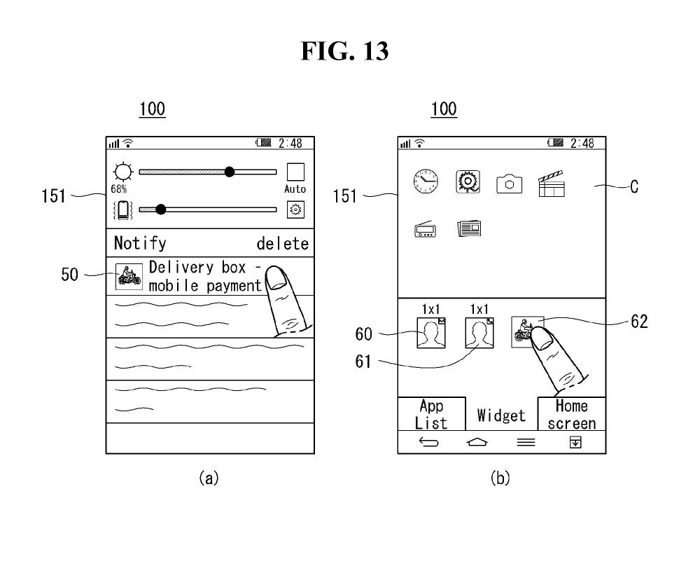

Referring to FIG. 13(a), the user can select the notification bar 50 indicating that the specific application has been installed. The controller 180 can display the screen on which the notification bar 50 is displayed in a translucent manner, as shown in FIG. 13(b). Referring to FIG. 13(c), the controller 180 can display the screen C for selecting a position of a widget corresponding to the specific application so the screen C and the screen displaying the notification bar 50 overlap.

However, the present invention is not limited thereto and the controller 180 can display the second screen shown in FIG. 11(b) so the second screen and the screen displaying the notification bar 50 overlap. Alternatively, the controller 180 can magnify the area 20 or the other area 40 of the second screen shown in FIG. 11(b) and display the magnified area such that the magnified area and the screen displaying the notification bar 50 overlap. In this instance, the user can select a display position of the icon of the specific application.

The controller 180 can simultaneously perform translucent display of the screen on which the notification bar 50 is displayed and display of the screen C for selecting a widget position. Furthermore, the controller 180 can sequentially perform translucent display of the screen on which the notification bar 50 is displayed and display of the screen C for selecting a widget position.

The user can select a display position of the widget 60 on the screen C. Upon selection of the display position of the widget 60, the controller 180 can restore the translucent screen displaying the notification bar 50, as shown in FIG. 13(d). Accordingly, the user can select the display position of the widget 60 while viewing the notification bar 50 indicating the state of the specific application.

While above description is based on the notification bar 50 indicating completion of installation of the specific application, the present invention is not limited thereto. According to an embodiment, the controller 180 can display a progress bar indicating installation of the specific application on the notification bar 50. In this instance, the user can select a position of the specific application icon even during installation of the specific application.

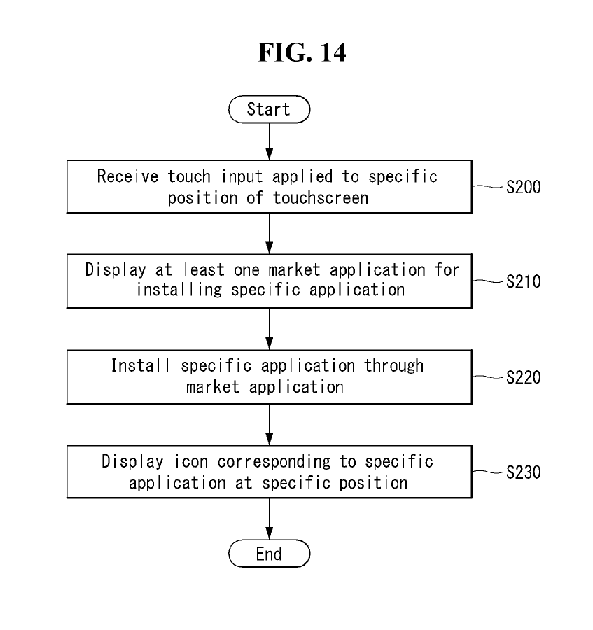

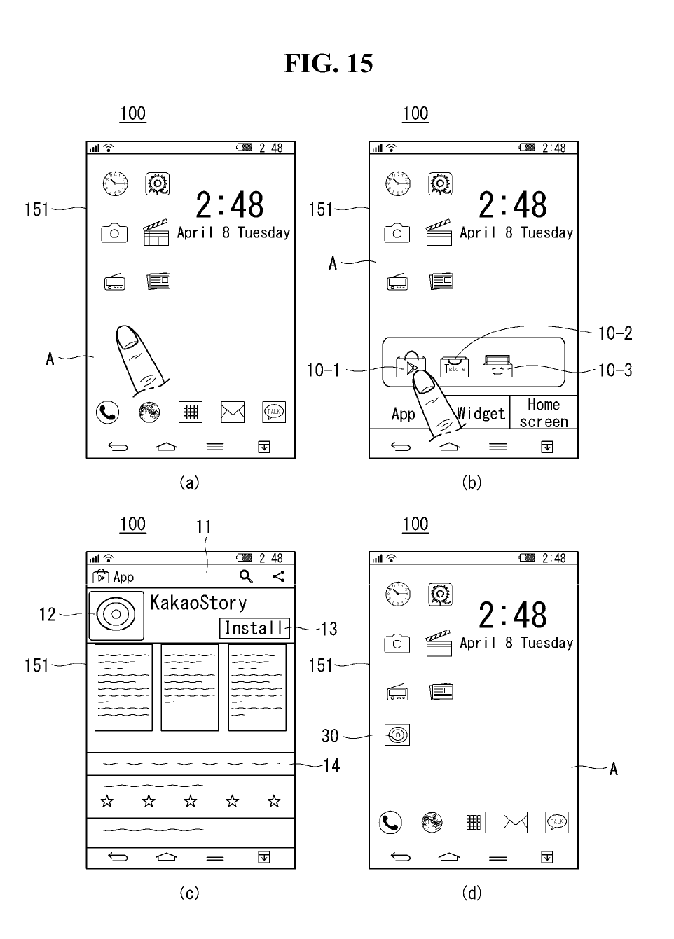

FIG. 14 is a flowchart illustrating a method for controlling a mobile terminal according to another embodiment of the present invention and FIGS. 15-17 illustrate direct display of an application icon at a selected specific position on the touchscreen according to an embodiment of the present invention. The method for controlling a mobile terminal according to another embodiment of the present invention can be implemented in the mobile terminal 100 described above with reference to FIG. 1.

Referring to FIG. 14, the controller 180 can receive a touch input applied to a specific position on the touchscreen 151 (S200). Referring to FIG. 15(a), the controller 180 can receive a predetermined touch input applied to a specific position on the home screen A. The predetermined touch input includes various touch inputs such as short touch, long touch and multi-touch or a combination thereof.

Referring back to FIG. 14, the controller 180 can display one or more market applications 10_1 to 10_3 for installing a specific application (S210). Referring to FIG. 15(b), the controller 180 can display the market applications 10_1 to 10_3 at the position to which the predetermined touch input is applied upon reception of the predetermined touch input. However, the display position of the market applications 10_1 to 10_3 is not limited thereto and may be determined differently as necessary.

Referring back to FIG. 14, the controller 180 can install the specific application through a market application (5220). The user can select one 10_1 of the displayed market applications 10_1 to 10_3, and can display an execution screen 11 of the selected market application 10_1 as shown in FIG. 15(c). The controller 180 can display an icon corresponding to the installed application on the execution screen 11 and display the installation button 13 for application installation on the execution screen 11. Further, the controller 180 can display the description region 14 with respect to the installed application on the execution screen 11, and when the user selects the installation button 13, install the specific application in the mobile terminal 100.

Referring back to FIG. 14, the controller 180 can display the icon 30 corresponding to the specific application at the specific position (S230). The controller 180 can display the icon 30 of the specific application at the specific position of the home screen A, as shown in FIG. 15(d). In this instance, the specific position may correspond to the position to which the predetermined touch input is applied. The user can easily select the display position of the icon of the specific application without additionally designating the display position through touch input applied to a desired position on the home screen A.

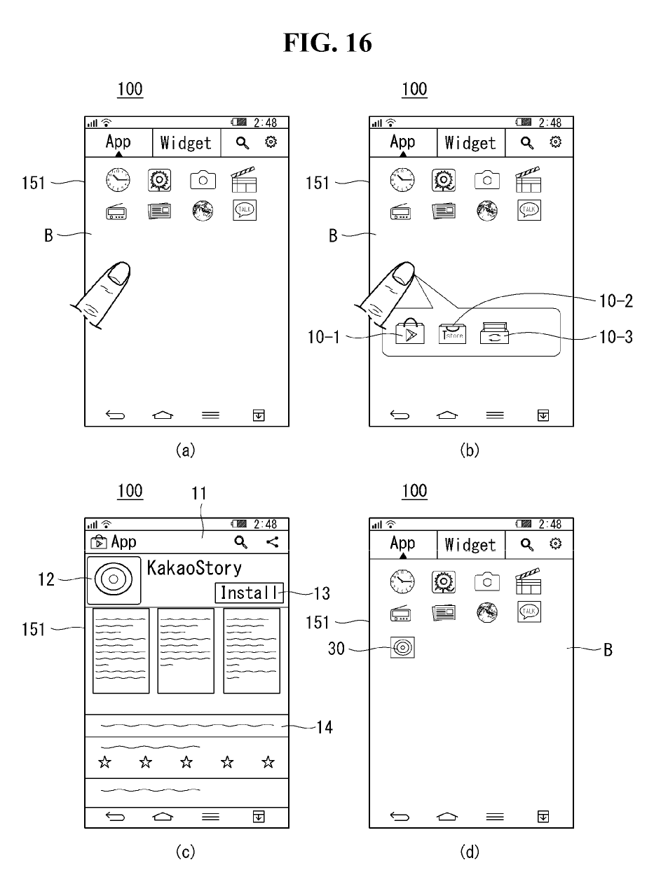

Referring to FIG. 16(a), the controller 180 can receive a predetermined touch input applied to a specific position of an application drawer B. The predetermined touch input includes touch inputs such as short touch, long touch and multi-touch or a combination thereof. Referring to FIG. 16(b), the controller 180 can display the market applications 10_1 to 10_3 at the position to which the predetermined touch input is applied upon reception of the predetermined touch input. However, the display position of the market applications 10_1 to 10_3 is not limited thereto and may be determined differently as necessary.

The user can select one 10_1 of the displayed market applications 10_1 to 10_3. The controller 180 can display the execution screen 11 of the selected market application 10_1, as shown in FIG. 16(c). When the user selects the installation button 13, the controller 180 can install the specific application in the mobile terminal 100.

The controller 180 can display the icon 30 of the specific application at the specific position of the application drawer B, as shown in FIG. 16(d). In this instance, the specific position may correspond to the position at which the predetermined touch input is applied. The user can easily select the display position of the icon of the specific application without additionally designating the display position through touch input applied to a desired position of the application drawer B.

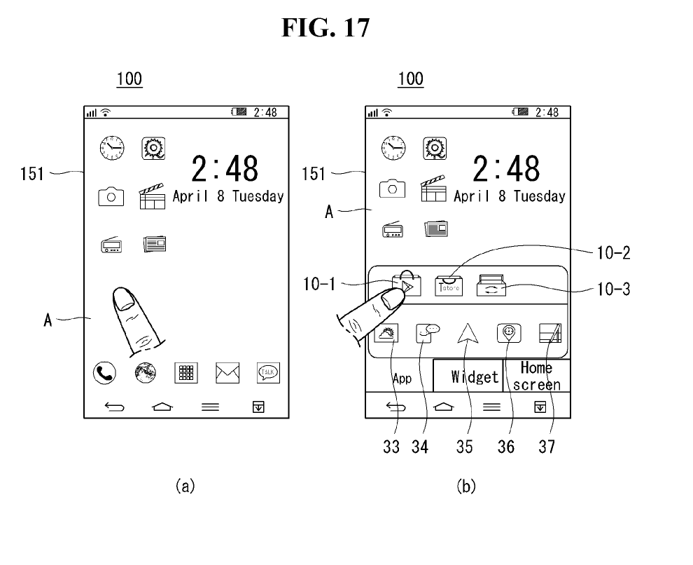

Referring to FIG. 17(a), the controller 180 can receive a predetermined touch input applied to a specific position on the home screen A. The predetermined touch input includes various touch inputs such as short touch, long touch and multi-touch or a combination thereof. Referring to FIG. 17(b), the controller 180 can display the market applications 10_1 to 10_3 at the position to which the predetermined touch input is applied upon reception of the predetermined touch input. However, the display position of the market applications 10_1 to 10_3 is not limited thereto and may be determined differently as necessary.

The controller 180 can display one or more recommended applications 33 to 37 along with the market applications 10_1 to 10_3. The recommended applications 33 to 37 may be applications related to a most recently executed application. For example, when a most recently executed application is a diary application, the controller 180 can display a schedule application, a gallery application and the like, related to the diary application, as recommended applications.

According to another embodiment, the controller 180 can display the recommended applications 33 to 37 based on the category of applications with high execution frequency according to the application use pattern of the user of the mobile terminal 100. For example, when a game application has highest execution frequency, the controller 180 can display game applications in a similar category to that of the executed game application as the recommended applications.

The user can select one of the recommended applications 33 to 37, and the controller 180 can display an icon corresponding to the selected recommended application at the specific position. Accordingly, the user can easily select a position at which an icon corresponding to a recommended application will be displayed. In addition, a specific application can be recommended to the user and thus the user can conveniently install a new application.

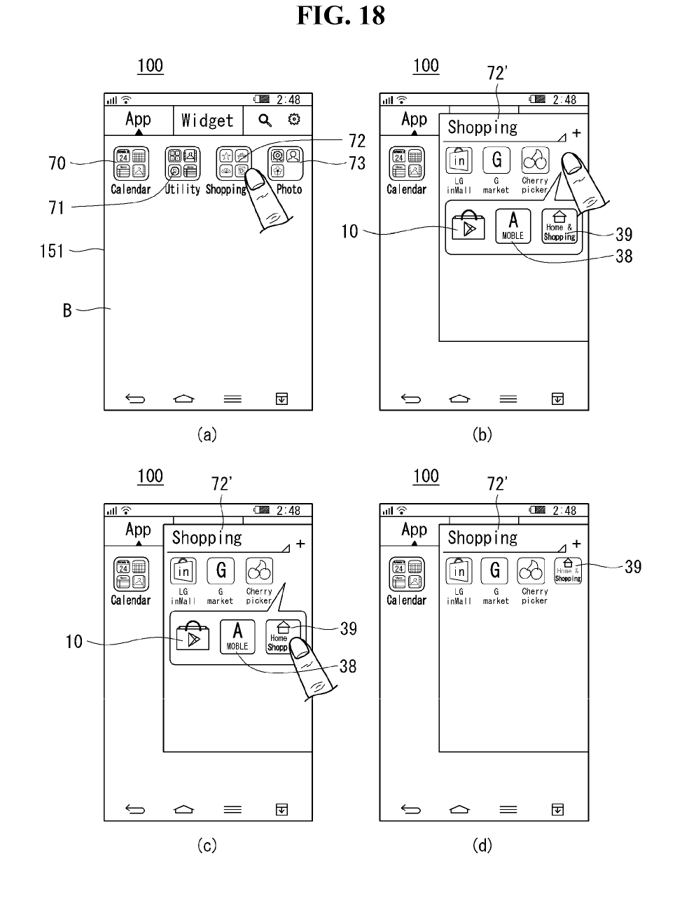

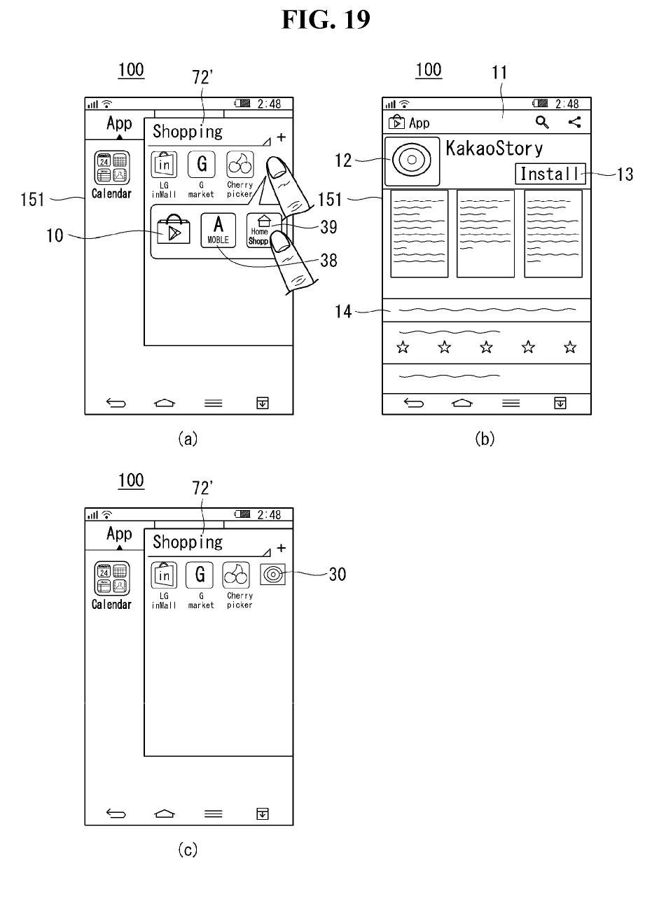

FIGS. 18 and 19 illustrate selection of an application icon display position from folders 70 to 73 according to an embodiment of the present invention. FIG. 18(a) shows that folder applications 70 to 73 are displayed per category in the application drawer B. The controller 180 can receive touch input applied to a folder 72 in a shopping category.

Referring to FIG. 18(b), the controller 180 can display an execution screen 72′ of the folder 72 in the shopping category. The controller 180 can receive a predetermined touch input applied to a specific position of the execution screen 72′. The predetermined touch input may be various touch inputs such as short touch, long touch and multi-touch or a combination thereof.

The controller 180 can display a market application 10 and one or more applications 38 and 39 related to the category of the selected folder 72. Referring to FIG. 18(c), the user can select a specific related application 39. Then, the controller 180 can display an icon corresponding to the selected application 39 at the specific position, as shown in FIG. 18(d). Accordingly, the user can easily arrange icons of related applications installed in the mobile terminal 100 by category, and thus application management convenience is improved.

Referring to FIG. 19(a), the controller 180 can receive touch input applied to a specific position of an execution screen 72′ of the folder 72 in the shopping category. The controller 180 can display the market application 10 and one or more applications 38 and 39 related to the category of the selected folder 72. The user can select the specific related application 39. When the selected application 39 has not been installed in the mobile terminal 100, the controller 180 can execute a market application capable of installing the selected application 39, as shown in FIG. 19(b).

The controller 180 can install the related application 39 upon reception of input applied to the installation button 13. The controller 180 can display the icon corresponding to the related application 39 at the specific position. Referring back to FIG. 18, when the user selects the market application 10, the controller 180 can display an execution screen of the market application 10. When the user installs a specific application, the controller 180 can display an icon of the specific application at the specific position.

Accordingly, the user can be provided with a related application according to the category of the folder and easily display the icon of the related application at a specific position of the folder. Therefore, there is no need for an additional process of installing the application and then moving the icon of the application to a specific folder.

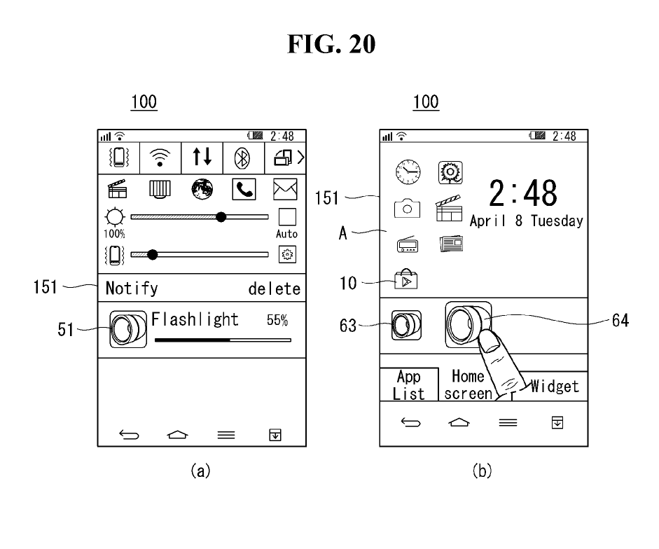

FIG. 20 illustrates selection of a size of a displayed application icon according to an embodiment of the present invention. Referring to FIG. 20(a), the controller 180 can display a notification bar 51 that indicates installation progress of a specific application. When the user selects the notification bar 51, the controller 180 can display icons 63 and 64 of the specific application in various sizes, as shown in FIG. 20(b). The controller 180 can display the home screen A through which display positions of the icons 63 and 64 can be selected along with the icons 63 and 63.

The user can select a specific icon 64 and drag the selected icon 64 to a desired position of the home screen A. The controller 180 can display the icon 64 selected by the user at the selected position. Accordingly, the user can easily select the size of the icon corresponding to the installed application. While the aforementioned operation is based on the home screen A and icons, the operation can be equally applied to the aforementioned application drawer, widget drawer and widgets.

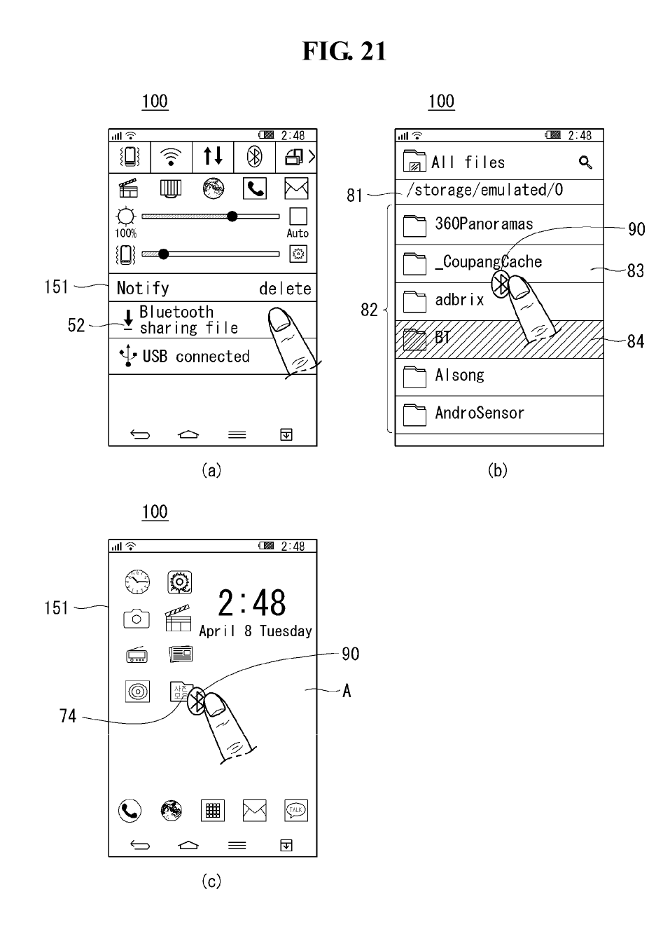

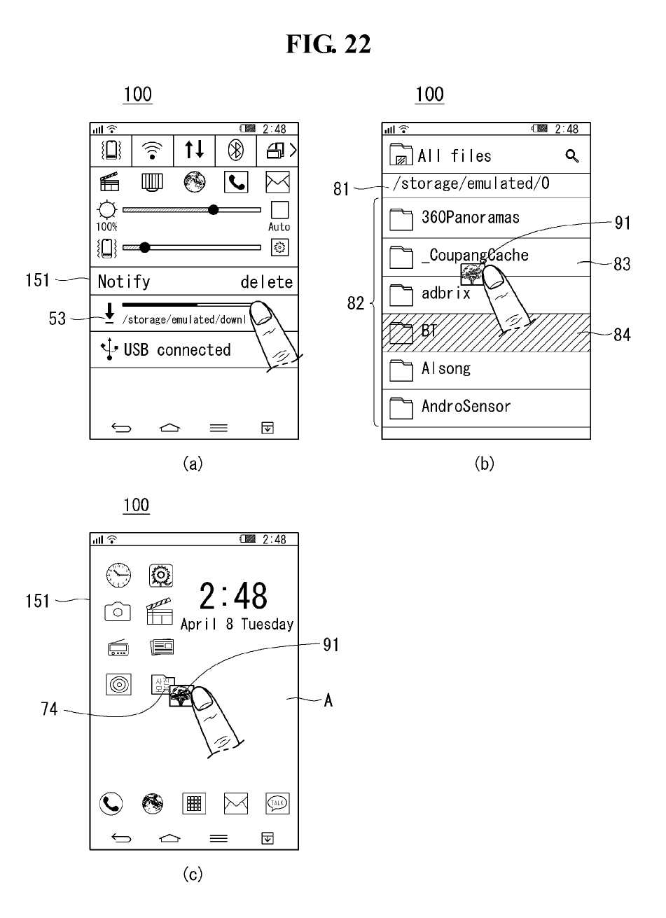

FIGS. 21 and 22 illustrate selection of a data storage position using a notification bar according to an embodiment of the present invention. Referring to FIG. 21(a), the controller 180 can display a notification bar 52 indicating that a specific file is shared using Bluetooth. This is and the notification bar 52 may indicate download state and other states in addition to file sharing.

The controller 180 can receive a predetermined touch input applied to the notification bar 52. The predetermined touch input includes touch inputs such as short touch, long touch and multi-touch or a combination thereof. Referring to FIG. 21(b), the controller 180 can display a shared file 90 at a position to which touch input of the user is applied. The controller 180 can display folders 82 in which the file can be stored and a folder path 81.

The controller 180 can display a folder 84 in which the shared file 90 is stored according to a predetermined standard such that the folder 84 is distinguished from other folders. While the folder 84 is shaded in FIG. 21(b), the folder 84 can be indicated in a color, shade or the like, different from those of other folders. The user can drag the shared file 90 to a folder 83 in which the user wants to store the shared file 90. Then, the controller 180 can move the shared file 90 from the folder 84 to the desired folder 83. However, the present invention is not limited thereto and the controller 180 can copy the shared file 90 to the desired folder 83 according to specific input.

According to another embodiment, the controller 180 can display a screen on which a folder capable of storing the shared file is displayed, as shown in FIG. 21(c). Referring to FIG. 21(c), the controller 180 can display the home screen A. However, the present invention is not limited thereto and the controller 180 can display the aforementioned pages, application drawer or reduced screens. Accordingly, the user can conveniently store a specific file at a desired position by selecting the notification bar without searching for the folder in which the specific file is stored.

Referring to FIG. 22(a), the controller 180 can display the notification bar 52 indicating download progress of a specific file. The controller 180 can receive a predetermined touch input applied to the notification bar 52. The predetermined touch input includes touch inputs such as short touch, long touch and multi-touch or a combination thereof. The controller 180 can display a downloaded file 91 at a position to which touch input of the user is applied, as shown in FIG. 22(b). The controller 180 can display the folders 82 in which the file can be stored and the folder path 81.

The controller 180 can display the folder 84 in which the downloaded file 91 is stored according to a predetermined standard such that the folder 84 is discriminated from other folders. While the folder 84 is shaded in FIG. 22(b), the folder 84 can be indicated in a color, shade or the like, different from those of other folders. The user can drag the downloaded file 90 to the folder 83 in which the user wants to store the downloaded file 91. Then, the controller 180 can move the downloaded file 90 from the folder 84 to the desired folder 83.

According to another embodiment, the controller 180 can display a screen on which a folder capable of storing the downloaded file 91 is displayed, as shown in FIG. 22(c). Referring to FIG. 22(c), the controller 180 can display the home screen A. However, the present invention is not limited thereto and the controller 180 can display the aforementioned pages, application drawer or reduced screens. Accordingly, the user can conveniently store a specific file at a desired position by selecting the notification bar without searching for the folder in which the specific file is stored during storage of the specific file.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the embodiments described herein may be combined in various ways to obtain additional and/or alternative embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal, comprising:
a wireless communication unit configured to provide wireless communication;
a touchscreen configured to display at least one page including at least one application icon; and
a controller configured to:
display a first screen for installing a specific application on the touchscreen,
display a second screen for setting a position at which an icon corresponding to the specific application will be displayed on the touchscreen after being installed, upon reception of an input for installing the specific application, and
display the icon of the specific application at the position on the touchscreen in response to a predetermined touch input on the displayed second screen.

2. The mobile terminal of claim 1, wherein the second screen includes at least one reduced screen corresponding to the at least one page.

3. The mobile terminal of claim 2, wherein the controller is configured to discriminately display icons corresponding to applications already installed and a free space for displaying the icon corresponding to the specific application to be installed.

4. The mobile terminal of claim 1, wherein the controller is configured to:
display a progress bar indicating a download progress of an installation file of the specific application on the first screen, and
display the second screen upon reception of an input applied to the progress bar.

5. The mobile terminal of claim 2, wherein the controller is configured to:
display at least one reduced screen in a first area of the second screen, and
display at least one other reduced screen corresponding to at least one application drawer in a second area of the second screen,
wherein the at least one application drawer includes collected icons corresponding to previously installed applications, and
wherein the icon corresponding to the specific application is displayed at a position within the application drawer.

6. The mobile terminal of claim 1, wherein the controller is configured to display an application drawer for selecting a display position of the icon of the specific application upon reception of a touch input applied to the displayed icon of the specific application, and
wherein the application drawer includes collected icons corresponding to previously installed applications.

7. The mobile terminal of claim 1, wherein the controller is configured to:
display the first screen translucently, and
display the second screen such that the second screen and the first screen overlap.

8. The mobile terminal of claim 7, wherein the controller is configured to restore the first screen and display the restored first screen upon selection of the position.

9. The mobile terminal of claim 1, wherein the controller is configured to display a virtual icon corresponding to the specific application that can be touched and dragged to the position of the icon of the specific application.

10. The mobile terminal of claim 9, wherein the controller is configured to display the virtual icon as a position corresponding to an installation button for installing the specific application in response to a touch input to the installation button.

11. The mobile terminal of claim 1, wherein the controller is configured to:
display a notification bar indicating an installation state of the specific application, and
display the second screen upon reception of an input for installing the specific application.

12. A mobile terminal, comprising:
a wireless communication unit configured to provide wireless communication;
a touchscreen; and
a controller configured to:
receive a first touch input at a specific position corresponding to an empty space of the touch screen,
display at least one market application for installing a specific application in response to the received first touch input,
receive a second touch input on the least one market application,
install the specific application through the market application, in response to the received second touch input, and
display an icon corresponding to the specific application at the specific position corresponding to the empty space of the touchscreen.

13. The mobile terminal of claim 12, wherein the controller is configured to:
display at least one recommended application along with the at least one market application in response to the received second touch input, and
display an icon corresponding to a selected recommended application at the specific position corresponding to the empty space of the touchscreen.

14. The mobile terminal of claim 12, wherein the controller is configured to:
display at least one application related to a category of a specific folder upon reception of a touch input applied to the specific folder, and
display an icon corresponding to a selected related application in the specific folder.

15. A method of controlling a mobile terminal, the method comprising:
displaying, via a touchscreen of the mobile terminal, at least one page including at least one application icon;
display, via the touchscreen, a first screen for installing a specific application on the touchscreen;
displaying, via the touchscreen, a second screen for setting a position at which an icon corresponding to the specific application will be displayed after being installed, upon reception of an input for installing the specific application; and
displaying, via the touchscreen, the icon of the specific application at the position on the touchscreen in response to a predetermined touch input on the displayed second screen.

16. The method of claim 15, wherein the second screen includes at least one reduced screen corresponding to the at least one page.

17. The method of claim 16, further comprising:
discriminately displaying icons corresponding to applications already installed and a free space for displaying the icon corresponding to the specific application to be installed.

18. The method of claim 15, further comprising:
displaying a progress bar indicating a download progress of an installation file of the specific application on the first screen; and
displaying the second screen upon reception of an input applied to the progress bar.

19. The method of claim 16, further comprising:
displaying at least one reduced screen in a first area of the second screen; and
displaying at least one other reduced screen corresponding to at least one application drawer in a second area of the second screen,
wherein the at least one application drawer includes collected icons corresponding to previously installed applications, and
wherein the icon corresponding to the specific application is displayed at a position within the application drawer.

20. The method of claim 15, further comprising:
displaying an application drawer for selecting a display position of the icon of the specific application upon reception of a touch input applied to the displayed icon of the specific application,
wherein the application drawer includes collected icons corresponding to previously installed applications.
